(19) United States
(12) Patent Application Publication
(10) Pub. No.: US 2026/0301126 A1
(43) Pub. Date: Oct. 1, 2026

(54) VIDEO GENERATION METHOD, APPARATUS, DEVICE, MEDIUM AND PRODUCT

(71) Applicant: Beijing Zitiao Network Technology Co., Ltd., Beijing (CN)

(72) Inventors: Tongchun ZUO, Beijing (CN); Xin DONG, Beijing (CN); Zaiyu HUANG, Beijing (CN)

(21) Appl. No.: 19/634,970

(22) Filed: Mar. 31, 2026

(30) Foreign Application Priority Data
Mar. 31, 2025 (CN) 202510398175.0

(51) Int. Cl. G06T 5/50; G06T 7/194; G06V 10/74

(52) U.S. Cl. CPC G06T 5/50; G06T 7/194; G06V 10/761; G06T 2207/20044; G06T 2207/20221

(57) ABSTRACT

The present application discloses a video generation method and apparatus, a device, a medium, and a product in the field of data processing technology. The method includes: obtaining a clothes image, a target video, a front image in the target video, and at least one key image in the target video, so that the clothes image may indicate a clothes constraint that needs to be satisfied in dressing processing, the front image may describe a state of an object in the target video in a front view angle, and each of the at least one key image has a difference from the front image in at least one dimension (such as a posture and/or a view angle).

### CROSS REFERENCE TO RELATED APPLICATIONS

This application is based on and claims priority of CN application with application No. 202510398175.0 filed on March 31, 2025, the entire disclosure of which is hereby incorporated by reference.

### TECHNICAL FIELD

The present application relates to the field of data processing technology and, in particular, to a video generation method, an apparatus, a device, a medium and a product.

### BACKGROUND

For some scenarios, such as a virtual try-on, video adjustment, animation production and other scenarios, these scenarios may have the following needs: generating a dressing video based on a clothes image, so that the dressing video satisfies a clothes constraint described by the clothes image.

### SUMMARY

In order to solve the above technical problems, the present application provides a video generation method, an apparatus, a device, a medium and a product.

In order to achieve the above objectives, the technical solutions provided by the present application are as follows:

The present application provides a video generation method, including: obtaining a clothes image, a target video, a front image in the target video, and at least one key image in the target video, where the front image describes a state of an object in the target video in a front view angle, each of the at least one key image has a difference from the front image in at least one dimension, and the at least one dimension includes a posture and/or a view angle; generating an image dressing result of the front image based on the clothes image and the front image; and generating a video dressing result of the target video based on the image dressing result, the at least one key image, and a skeleton extraction result of each frame image in the target video.

In a possible implementation, the generating the video dressing result of the target video based on the image dressing result, the at least one key image, and the skeleton extraction result of each frame image in the target video includes: generating the video dressing result of the target video based on the image dressing result, the at least one key image, the skeleton extraction result of each frame image in the target video, and a background extraction result of each frame image in the target video.

In a possible implementation, the method further includes: obtaining an image dressing result of each of the at least one key image; and the generating the video dressing result of the target video based on the image dressing result, the at least one key image, and the skeleton extraction result of each frame image in the target video includes: generating the video dressing result of the target video based on the image dressing result of the front image, the image dressing result of each of the at least one key image, and the skeleton extraction result of each frame image in the target video.

In a possible implementation, the obtaining the image dressing result of each of the at least one key image includes: for any key image of the at least one key image, generating an image dressing result of the key image based on the image dressing result of the front image, a skeleton extraction result of the key image, and a background extraction result of the key image.

In a possible implementation, the obtaining the clothes image includes: obtaining a plurality of clothes images, where the plurality of clothes images all indicate a same piece of clothing, and different images in the plurality of clothes images indicate different view angles; the generating the image dressing result of the front image based on the clothes image and the front image includes: generating the image dressing result of the front image based on the front image and a clothes image, which is included in the plurality of clothes images and whose view angle matches a view angle indicated by the front image; and the obtaining the image dressing result of each of the at least one key image includes: generating the image dressing result of each of the at least one key image based on the plurality of clothes images and the at least one key image.

In a possible implementation, the generating the image dressing result of each of the at least one key image based on the plurality of clothes images and the at least one key image includes: for any key image of the at least one key image, in response to there being a clothes image, which is included in the plurality of clothes images and whose view angle matches a view angle indicated by the key image, generating the image dressing result of the key image based on the key image and the clothes image whose view angle matches the view angle indicated by the key image.

In a possible implementation, the generating the image dressing result of each of the at least one key image based on the plurality of clothes images and the at least one key image includes: in response to there being a difference between a view angle indicated by the plurality of clothes images and a view angle indicated by the at least one key image, for any clothes image, other than the clothes image whose view angle matches the view angle indicated by the front image, of the plurality of clothes images, generating an image dressing result corresponding to the clothes image based on the clothes image and an image, which is included in the target video and whose view angle matches a view angle indicated by the clothes image; and for any key image of the at least one key image, generating the image dressing result of the key image based on image dressing results corresponding to each clothes image, other than the clothes image whose view angle matches the view angle indicated by the front image, of the plurality of clothes images, the image dressing result of the front image, a skeleton extraction result of the key image, and a background extraction result of the key image.

In a possible implementation, an obtaining process of the clothes image includes: obtaining a target image, where an object in the target image has different clothes from an object in the target video; and determining the clothes image based on a clothes extraction result of the target image.

In a possible implementation, an obtaining process of the front image includes: obtaining a reference skeleton indicating the front view angle; and determining the front image from the target video based on a similarity between the reference skeleton and a skeleton extraction result of each frame image in the target video, a similarity between the reference skeleton and a skeleton extraction result of the front image being not lower than a similarity between the reference skeleton and a skeleton extraction result of each of other frame images, other than the front image, in the target video.

In a possible implementation, an obtaining process of the at least one key image includes: obtaining a reference skeleton indicating the front view angle; selecting a first image from the target video based on a similarity between the reference skeleton and a skeleton extraction result of each frame image in the target video, a similarity between the reference skeleton and a skeleton extraction result of the first image being not higher than a similarity between the reference skeleton and a skeleton extraction result of each of other frame images, other than the first image, in the target video; and determining the at least one key image based on the first image, where the at least one key image includes the first image.

In a possible implementation, after the determining the at least one key image based on the first image, the method further includes: selecting a second image from a difference set between the target video and the at least one key image, a similarity between a skeleton extraction result of the second image and a skeleton extraction result of each of the at least one key image being less than a preset threshold; and updating the at least one key image based on the second image, the at least one updated key image including the second image, and the step of selecting the second image from the difference set between the target video and the at least one key image being continuously performed.

In a possible implementation, before the generating the video dressing result of the target video based on the image dressing result, the at least one key image, and the skeleton extraction result of each frame image in the target video, the method further includes: in response to the number of images in the at least one key image exceeding a preset number, for any image in the at least one key image, summing similarities between a skeleton extraction result of the image and skeleton extraction results of other images than the image, in the at least one key image to obtain a sum corresponding to the image; and deleting a third image satisfying a condition from the at least one key image based on the sum corresponding to each image in the at least one key image, a sum corresponding to each image in at least one remaining key image being not greater than a sum corresponding to the third image, and the number of images in the at least one remaining key image being the preset number.

In a possible implementation, a determining process of the preset threshold includes: calculating an average value of similarities between the reference skeleton and the skeleton extraction result of each frame image in the target video; and determining the preset threshold based on the average value.

In a possible implementation, for any image in the target video, the similarity between the reference skeleton and the skeleton extraction result of the image indicates a similarity degree between a skeleton orientation angle determined from the skeleton extraction result of the image and a skeleton orientation angle determined from the reference skeleton.

In a possible implementation, the at least one dimension includes some or all of the posture, the view angle, a background and light.

The present application provides a video generation apparatus, including: a data obtaining unit, configured to obtain a clothes image, a target video, a front image in the target video, and at least one key image in the target video, where an object in the target video has different clothes from clothes indicated by the clothes image, the front image describes a state of the object in a front view angle, each of the at least one key image has a difference from the front image in at least one dimension, and the at least one dimension includes a posture and/or a view angle; a first generation unit, configured to generate an image dressing result of the front image based on the clothes image and the front image, where clothes of an object in the image dressing result are consistent with the clothes indicated by the clothes image; and a second generation unit, configured to generate a video dressing result of the target video based on the image dressing result, the at least one key image, and a skeleton extraction result of each frame image in the target video, where clothes of an object in the video dressing result are consistent with the clothes indicated by the clothes image.

The present application provides an electronic device, including: a processor and a memory, where the memory is configured to store an instruction or a computer program, and the processor is configured to execute the instruction or the computer program in the memory to cause the electronic device to perform the video generation method provided by the present application.

The present application provides a computer-readable medium, where an instruction or a computer program is stored in the computer-readable medium, and the instruction or the computer program, when running on a device, causes the device to perform the video generation method provided by the present application.

The present application provides a computer program product, which includes a computer program carried on a non-transitory computer-readable medium, where the computer program includes program code for performing the video generation method provided by the present application.

### BRIEF DESCRIPTION OF THE DRAWINGS

In order to more clearly explain the technical solutions in the embodiments of the present application or in related technologies, the following briefly introduces the drawings that need to be used in the description of the embodiments or related technologies. Obviously, the drawings in the following description are merely some embodiments of the present application, and for those of ordinary skill in the art, other drawings may also be obtained based on these drawings without creative efforts.

FIG. 1 is a flowchart of a video generation method according to an embodiment of the present application;

FIG. 2 is a schematic diagram of a dressing processing flow for a video according to an embodiment of the present application;

FIG. 3 is a schematic diagram of a skeleton image according to an embodiment of the present application;

FIG. 4 is a schematic diagram of a generation flow of an image dressing result according to an embodiment of the present application;

FIG. 5 is a schematic diagram of a generation flow of a video dressing result according to an embodiment of the present application;

FIG. 6 is a schematic structural diagram of a video generation apparatus according to an embodiment of the present application; and

FIG. 7 is a schematic structural diagram of an electronic device according to an embodiment of the present application.

### DETAILED DESCRIPTION OF EMBODIMENTS

Research has found that in some scenarios, in order to implement the above-mentioned requirement of "generating a dressing video based on a clothes image", the following solution is proposed: first, performing image dressing on a person image provided by a user based on the clothes image to obtain an image dressing result; and then generating a dressing video based on the image dressing result and a text prompt provided by the user that may indicate an action change expected to be displayed by the user. It should be noted that the present application does not limit a generation manner of the dressing video, for example, the dressing video may be generated by using a large image-to-video model.

Research has further found that the solution shown in the preceding paragraph has the following defects: because the solution indicates the action change through the text prompt, the dressing video generated under the constraint of the text prompt is prone to a phenomenon that does not meet user expectations, which requires the user to try by repeatedly adjusting the text prompt, resulting in low efficiency of obtaining the dressing video.

Research has further found that in order to reduce the impact caused by the defects shown in the preceding paragraph, the following solution is proposed: first, performing image dressing on a person image provided by a user based on a clothes image to obtain an image dressing result; and then generating a dressing video based on the image dressing result and a skeleton image sequence provided by the user that may indicate an action change expected to be displayed by the user. The skeleton image sequence may describe some action changes.

Research has further found that the solution shown in the preceding paragraph has the following defects: because the person image may only describe features of the person presented in a certain view angle (such as a front view angle) and a certain posture (such as a standing posture), the person image cannot accurately describe features of the person presented in other view angles and other postures. Therefore, when the above-mentioned skeleton image sequence indicates a large-scale turn (such as a 180-degree turn) or a large-scale motion, the dressing video generated based on the skeleton image sequence and the image dressing result of the person image is prone to some problems (such as incorrect mapping and texture instability), which affects the quality of video generation.

Based on the above research, in order to better improve the quality of video generation, the present application provides a video generation method, including: obtaining a clothes image, a target video, a front image in the target video, and at least one key image in the target video, so that the clothes image may indicate a clothes constraint that needs to be satisfied in dressing processing, the front image may describe a state of an object in the target video in a front view angle, and each of the at least one key image has a difference from the front image in at least one dimension (such as a posture and/or a view angle). In this way, after an image dressing result of the front image is generated based on the clothes image and the front image, a video dressing result of the target video may be generated based on the image dressing result, the at least one key image, and a skeleton extraction result of each frame image in the target video. In this way, a dressing video may be automatically generated based on the clothes image.

In addition, although the front image may describe some features of the object in the target video, the front image cannot comprehensively describe all features of the object (such as posture motion features) presented in the target video. In addition, each of the at least one key image has a difference from the front image in at least one dimension (such as a posture and/or a view angle), so that the at least one key image may provide some more detailed supplementary information (such as information about a state presented by the object during a large-scale motion) about the object described in the front image in these dimensions. Therefore, the features of the object described in the target video may be described as comprehensively as possible in combination with the at least one key image and the front image, so that enough features of the object may be obtained from the at least one key image and an image dressing result of the front image when the video dressing result is subsequently generated. In this way, the quality of video generation may be effectively improved, for example, the quality of video generation in the case of a large-scale motion of the object may be significantly improved.

In addition, the present application does not limit an execution body of the video generation method, for example, the method may be applied to a terminal device or a server. For another example, the method may also be implemented by means of a data interaction process between a terminal device and a server. The terminal device may be a smartphone, a computer, a personal digital assistant (PDA), a tablet computer, etc. The server may be an independent server, a cluster server or a cloud server.

In order to enable those skilled in the art to better understand the solutions of the present application, the technical solutions in the embodiments of the present application will be clearly and completely described below with reference to the drawings in the embodiments of the present application. Obviously, the described embodiments are merely some embodiments of the present application, rather than all the embodiments. All other embodiments obtained by those of ordinary skill in the art based on the embodiments of the present application without creative efforts shall fall within the protection scope of the present application.

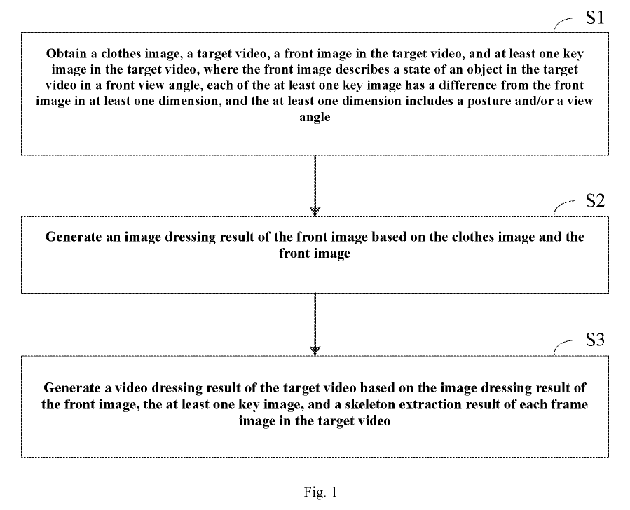

In order to better understand the technical solutions provided by the present application, the video generation method provided by the present application will be described below with reference to some drawings. As shown in FIG. 1, the video generation method provided by an embodiment of the present application includes the following S1-S3.

S1: obtaining a clothes image, a target video, a front image in the target video, and at least one key image in the target video, where the front image describes a state of an object in the target video in a front view angle, and each of the at least one key image has a difference from the front image in at least one dimension, the at least one dimension including a posture and/or a view angle.

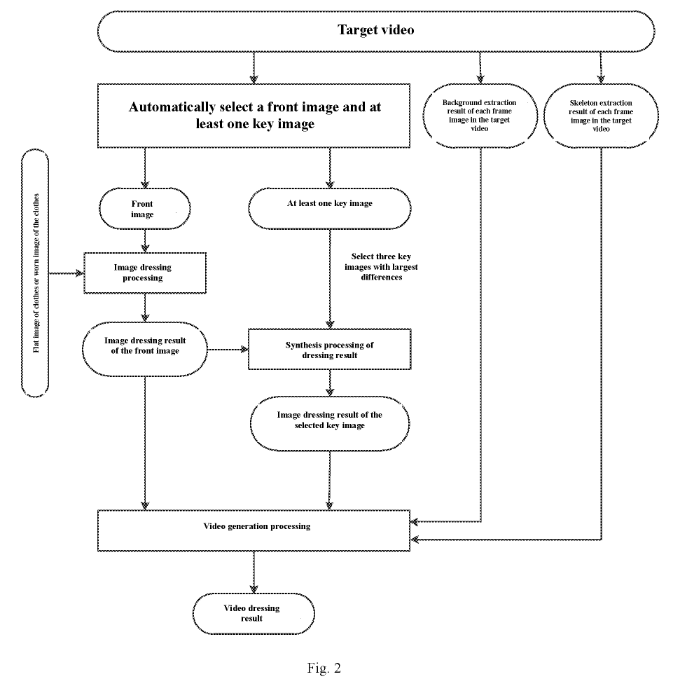

The clothes image refers to an image (a flat image or a worn image shown in FIG. 2) that is obtained in a certain manner and that may indicate a clothes constraint that needs to be satisfied in dressing processing.

In addition, the present application does not limit an implementation of the clothes image, for example, for any piece of clothing (clothes shown in FIG. 2), a clothes image used to describe features of the piece of clothing may be implemented by using a flat image (the flat image shown in FIG. 2) of the piece of clothing, so that the clothes image may describe a state of the piece of clothing in a certain view angle (such as a front view angle). For another example, the clothes image may be implemented by using an image (a worn image of the piece of clothing or the worn image shown in FIG. 2) that may describe an object that wears the piece of clothing, so that the clothes image may not only indicate what the piece of clothing looks like, but also indicate a worn effect of the piece of clothing.

In addition, the present application does not limit a manner of obtaining the clothes image, for example, the clothes image may be provided by a user by using some input devices. For another example, the clothes image may be provided by another data processing task that has been completed or is being performed on a current device (such as an execution device of the above video generation method).

The target video refers to data (the target video shown in FIG. 2) that is obtained in a certain manner and that may indicate some or all constraints (such as a body posture change, a view angle change, and a background change) other than clothes that need to be satisfied in the dressing processing. It should be noted that the present application does not limit a relationship between clothes of the object in the target video and the clothes indicated by the above clothes image, for example, the clothes of the object in the target video may be different from the clothes indicated by the clothes image, so that the object in the target video may be subsequently replaced from the clothes that the object has been wearing to the clothes indicated by the clothes image by means of the dressing processing. The object refers to a foreground of each frame image in the target video; and the present application does not limit an implementation of the object, for example, the object may be implemented by using a real person image, a virtual image, an animated image, or any other object that may wear clothes.

In addition, the present application does not limit an implementation of the target video, for example, the target video may be implemented by using any video that may describe a state (such as an action change) of an object.

In addition, the present application does not limit a manner of obtaining the target video, for example, the target video may be provided by a user by using some input devices. For another example, the target video may be provided by another data processing task that has been completed or is being performed on a current device (such as an execution device of the above video generation method).

The front image in the target video refers to an image (the front image shown in FIG. 2) that is included in the target video and that may describe, in the front view angle, the state of the object in the target video, so that a dressing video may be better generated subsequently under the guidance of the front image. The front view angle indicates that a camera is directly facing the object to be shot during a shooting process of the target video, so that an image shot based on the front view angle may show an entire appearance (such as a five sense organs distribution of a face, a position distribution of different body parts, and a height, a build, etc.) of the object to be shot as completely as possible, thereby enabling the image shot based on the front view angle to present details and texture of the object to be shot as much as possible.

In addition, in some scenarios, in order to better improve a dressing effect, the front image may satisfy at least the following constraints: the front image is included in the target video, a view angle indicated by the front image is equal to or as close as possible to the front view angle, and a posture of the object in the front image is equal to or as close as possible to a preset posture (such as a standing posture, a T posture, or a Y posture), so that the front image may describe as many body details of the object as possible, so as to be able to predict dressing results in other postures and/or other view angles subsequently under the guidance of the front posture.

It may be learned that in a possible implementation, the front image may refer to an image that is included in the target video and that may describe, in the front view angle, features of the object in the target video in the preset posture, so that the front image may describe as many body details of the object as possible.

In addition, the present application does not limit a manner of obtaining the front image, for example, the front image may be an image manually selected by a user from the target video. For another example, the front image may be determined by a machine learning model that is pre-built and that may select a front image from any video (such as the target video). It should be noted that the present application does not limit an implementation of the machine learning model.

The at least one key image in the target video refers to an image (the at least one key image shown in FIG. 2) that is included in the target video and that may provide information supplementary to the front image, so that features (such as a posture change, a view angle change, and a background change) of the object presented in the target video may be described as much as possible in a subsequent manner of combining the at least one key image and the front image. It should be noted that the posture may indicate a body posture of the object when an image is shot for the object, the view angle may indicate a shooting view angle used when the image is shot for the object, and the background may indicate other content in a shot other than the object when the image is shot for the object.

In addition, the at least one key image may satisfy at least the following constraints: the at least one key image is included in the target video, and each of the at least one key image has a difference from the front image in the target video in at least one dimension (such as a posture and/or a view angle), so that the at least one key image may supplement some features (such as a body feature during a large-scale action) of the object that cannot be provided by the front image. The at least one dimension refers to a dimension that needs to be referred to when the key image is selected, so that the at least one dimension may describe, to some extent, in which aspect the front image has deficiencies; and the present application does not limit the at least one dimension, for example, the at least one dimension may include a posture and/or a view angle, so that the at least one dimension may represent that the front image cannot describe all features of the object in the target video presented in the posture and/or the view angle, thereby enabling the key image selected based on the at least one dimension to supplement as many features as possible of the object presented in the posture and/or the view angle.

In addition, the present application does not limit a manner of obtaining the at least one key image, for example, the at least one key image may be an image manually selected by a user from the target video. For another example, the at least one key image may be determined by a machine learning model that is pre-built and that may select, from any video (such as the target video), an image that has a large difference from a front image. It should be noted that the present application does not limit an implementation of the machine learning model.

S2: generating an image dressing result of the front image based on the clothes image and the front image.

The image dressing result of the front image is obtained by performing dressing processing on the front image based on the clothes image, so that the image dressing result may represent a state presented after an object in the front image is replaced from clothes that the object has been wearing to the clothes indicated by the clothes image, thereby enabling clothes of the object in the image dressing result to be consistent with the clothes indicated by the clothes image.

It may be learned that in a possible implementation, the image dressing result of the front image may satisfy at least the following constraints: clothes of the object in the image dressing result are consistent with (for example, exactly the same as or highly similar in style to) the clothes indicated by the clothes image, and a state of the image dressing result is consistent with that of the front image in aspects other than clothes.

It should be noted that the "being consistent" involved in the present application refers to being the same or highly similar (that is, similarity is higher than a preset similarity threshold) or being highly similar in some aspects (such as style). As an example, if information 1 is consistent with information 2, it may be determined that the information 1 is exactly the same as the information 2, or it may be determined that the similarity between the information 1 and the information 2 exceeds the similarity threshold, or the similarity between the information 1 and the information 2 in some aspects exceeds the similarity threshold.

In addition, the present application does not limit an implementation of S2, for example, S2 may be implemented by using any method that may perform dressing processing on an image, such as any image dressing algorithm or a machine learning model with an image dressing function. It should be noted that the present application does not limit an implementation of the machine learning model.

In addition, in some scenarios, such as a body shape adjustment scenario or a skin tone adjustment scenario, in order to better meet a user requirement (such as a slimming requirement), S2 may specifically include: generating the image dressing result of the front image based on the clothes image, the front image, and a text that may indicate the user requirement, so that the image dressing result may satisfy at least the following constraints: clothes of the object in the image dressing result are consistent with the clothes indicated by the clothes image, the image dressing result satisfies a constraint (such as a constraint of slimming down according to a certain ratio) indicated by the text, and a state of the image dressing result is consistent with that of the front image in aspects other than clothes and a state (such as a fatness and thinness degree) constrained by the text.

S3: generating a video dressing result of the target video based on the image dressing result of the front image, the at least one key image, and a skeleton extraction result of each frame image in the target video.

For an ith image in the target video, the skeleton extraction result of the ith image is obtained by performing skeleton extraction processing on the ith image, so that the skeleton extraction result may represent a state (such as a posture and/or a view angle) of the object in the ith image, where i is a positive integer, and i is less than or equal to the number of images in the target video.

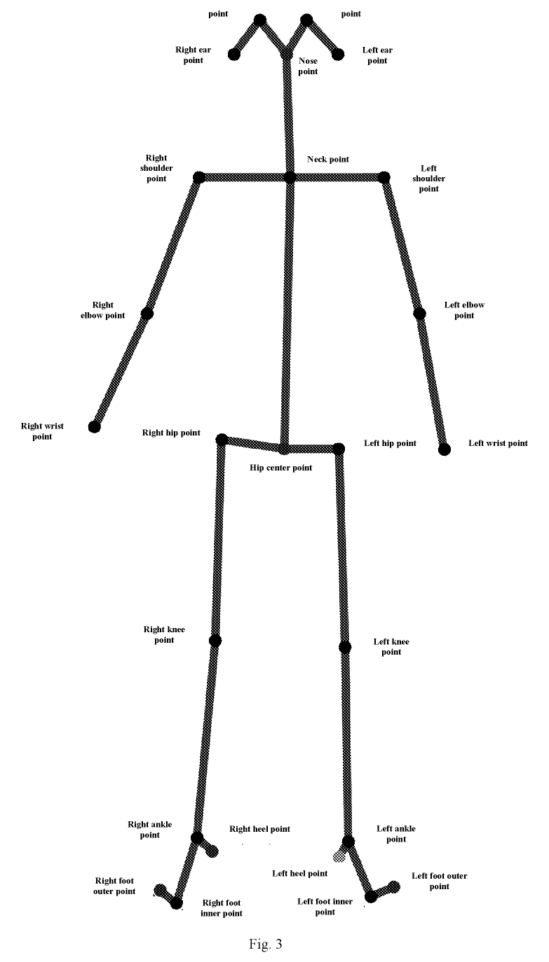

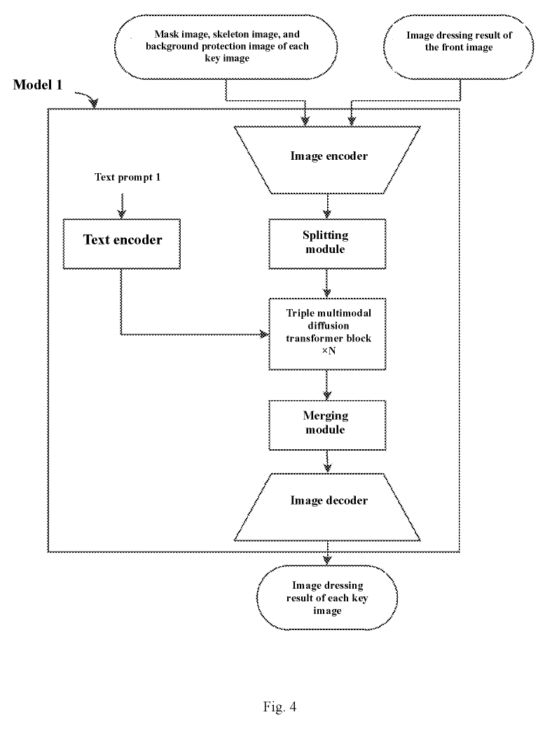

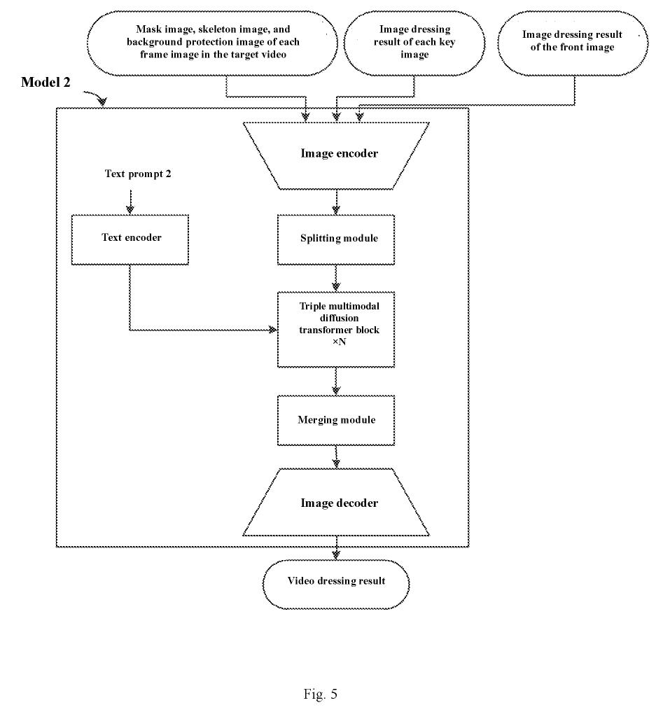

In addition, the present application does not limit an implementation of the skeleton extraction result, for example, the skeleton extraction result may be implemented by using an image (a skeleton image shown in FIG. 3, FIG. 4, or FIG. 5).

In addition, the present application does not limit a manner of obtaining the skeleton extraction result, for example, the skeleton extraction result may be obtained by using any method that may extract a skeleton from an image, such as any skeleton extraction algorithm or a machine learning model with a skeleton extraction function. It should be noted that the present application does not limit an implementation of the machine learning model.

The video dressing result (also referred to as a dressing video) of the target video refers to a video (the video dressing result shown in FIG. 2) obtained by performing dressing processing on the target video, so that the video dressing result may represent a state presented after the object in the target video is replaced from clothes that the object has been wearing to the clothes indicated by the clothes image.

It may be learned that in a possible implementation, the video dressing result of the target video may satisfy at least the following constraints: clothes of the object in the video dressing result are consistent with the clothes indicated by the clothes image, and a state of the video dressing result is consistent with that of the target video in aspects other than clothes.

In addition, the present application does not limit an implementation of S3, for example, S3 may be implemented by using any machine learning model that may perform video generation processing based on a plurality of conditions (such as the image dressing result of the front image, the at least one key image, and the skeleton extraction result of each frame image in the target video), for example, a diffusion model (Diffusion Transformer, DIT) based on a Transformer architecture.

It may be learned that in a possible implementation, S3 may specifically include: inputting the image dressing result of the front image, the at least one key image, and the skeleton extraction result of each frame image in the target video into a pre-built DIT having a function of generating a video under the guidance of the plurality of conditions, so that the DIT may perform video generation (such as generation processing similar to that shown in FIG. 5) based on the input data, to obtain and output the video dressing result of the target video, so that clothes of the object in the video dressing result are consistent with the clothes indicated by the clothes image.

In addition, in some scenarios, such as a body shape adjustment scenario or a skin tone adjustment scenario, in order to better meet a user requirement (such as a slimming requirement), S3 may specifically include: generating the video dressing result of the target video based on the image dressing result of the front image, the at least one key image, the skeleton extraction result of each frame image in the target video, and a text (text prompt 2 shown in FIG. 5) that may indicate the user requirement, so that the video dressing result may satisfy at least the following constraints: clothes of the object in the video dressing result are consistent with the clothes indicated by the clothes image, the video dressing result satisfies a constraint (such as a constraint of slimming down according to a certain ratio) indicated by the text, and a state of the video dressing result is consistent with that of the target video in aspects other than clothes and a state (such as a fatness and thinness degree) constrained by the text.

It may be learned based on related content of S1 to S3 that, in the video generation solution provided by the present application, a clothes image, a target video, a front image in the target video, and at least one key image in the target video are obtained, so that the clothes image may indicate a clothes constraint that needs to be satisfied in dressing processing, the front image may describe a state of an object in the target video in a front view angle, and each of the at least one key image has a difference from the front image in at least one dimension (such as a posture and/or a view angle). In this way, after an image dressing result of the front image is generated based on the clothes image and the front image, a video dressing result of the target video may be generated based on the image dressing result, the at least one key image, and a skeleton extraction result of each frame image in the target video. In this way, a dressing video may be automatically generated based on the clothes image. In addition, although the front image may describe some features of the object in the target video, the front image cannot comprehensively describe all features (such as posture motion features) of the object presented in the target video. In addition, each of the at least one key image has a difference from the front image in at least one dimension (such as a posture and/or a view angle), so that the at least one key image may provide some more detailed supplementary information (such as information about a state presented by the object during a large-scale motion) about the object described in the front image in these dimensions. Therefore, the features of the object described in the target video may be described as comprehensively as possible in combination with the at least one key image and the front image, so that enough features of the object may be obtained from the at least one key image and an image dressing result of the front image when the video dressing result is subsequently generated. In this way, the quality of video generation may be effectively improved, for example, the quality of video generation in the case of a large-scale motion of the object may be significantly improved.

It is found through research that in some scenarios, such as a scenario with a high requirement for the quality of video generation, the target video describes not only a posture change and a view angle change, but also some other changes (such as a background change). Therefore, in order to ensure that these changes may be retained as completely as possible during the dressing processing, the present application further provides a possible implementation of the at least one dimension. In this implementation, the at least one dimension may include some or all of a posture, a view angle, a background, and light, so that the at least one dimension may describe as comprehensively as possible in which aspects the front image has deficiencies, thereby enabling the key image selected based on the at least one dimension to supplement as comprehensively as possible information lacking in the front image, and enabling the dressing video generated under the guidance of the key image and the front image to be better. This helps improve the dressing effect.

In addition, in some scenarios, such as a scenario in which emphasis is placed on retaining a background of the original video or a scenario in which a background change in the original video is relatively large, in order to better improve a background retaining effect, S3 may include: generating the video dressing result of the target video based on the image dressing result of the front image, the at least one key image, the skeleton extraction result (the skeleton extraction result shown in FIG. 2) of each frame image in the target video, and a background extraction result (the background extraction result shown in FIG. 2) of each frame image in the target video, so that the video dressing result may satisfy at least the following constraints: clothes of the object in the video dressing result are consistent with the clothes indicated by the clothes image, and a background change in the video dressing result is consistent with a background change in the target video. This helps better implement the dressing processing while retaining the background, thereby helping better improve the dressing effect.

It may be learned that in a possible implementation, when S3 is implemented by using a pre-built DIT having a function of generating a video under the guidance of a plurality of conditions, S3 may specifically include: inputting the image dressing result of the front image, the at least one key image, the skeleton extraction result of each frame image in the target video, and the background extraction result of each frame image in the target video into the DIT, so that the DIT may perform video generation based on the input data, to obtain and output the video dressing result of the target video. In this way, the dressing processing may be implemented while retaining as many original details in the target video as possible, thereby helping better improve the dressing effect.

For an ith image in the target video, the background extraction result of the ith image is obtained by performing background extraction processing on the ith image, so that the background extraction result may represent background information carried by the ith image, where i is a positive integer, and i is less than or equal to the number of images in the target video.

In addition, the present application does not limit an implementation of the background extraction result, for example, the background extraction result may be implemented in an image manner (the background protection image shown in FIG. 4 or FIG. 5).

In addition, the present application does not limit a manner of obtaining the background extraction result, for example, the background extraction result may be obtained by using any method that may extract background information from an image, such as any background extraction algorithm (such as a body segmentation algorithm) or a machine learning model with a background extraction function. It should be noted that the present application does not limit an implementation of the machine learning model.

It may be learned that in a possible implementation, for an ith image in the target video, a process of determining the background extraction result of the ith image may include: first performing body segmentation processing on the ith image to obtain a segmentation result, so that the segmentation result may at least indicate a position of the object in the ith image; and then processing (such as occlusion processing implemented by adding a mask image) the object in the ith image based on the segmentation result to obtain the background extraction result of the ith image, so that the object described in the ith image does not exist in the background extraction result, for example, content enclosed by a bounding box (also referred to as a body box) of the object in the ith image does not exist in the background extraction result, but other content (such as a background) other than the object that is described in the ith image exists in the background extraction result. Therefore, background details in the ith image may be described as completely as possible in the background extraction result, so that the dressing video generated under the guidance of the background extraction result may retain these background details as completely as possible. This helps better improve the dressing effect.

It should be noted that the mask image refers to a mask that may occlude a certain part in an image, and the mask refers to an image that carries no information and that covers the part that needs to be occluded. For example, for an image, if it is desired to retain the object in the image, a mask image may be added to a part (such as a background) other than the object in the image, so that only the object is retained in the image after the addition, and the mask image may describe, to some extent, a position of the "part other than the object" in the image. However, if it is desired to retain the background in the image, a mask image may be added to a part (such as the object) other than the background in the image, so that only the background is retained in the image after the addition, and the mask image may describe, to some extent, a position of the "part other than the background" in the image.

In addition, in some scenarios, such as a scenario with a high requirement for the quality of video generation, in order to better improve a generation effect, S3 may include: generating the video dressing result of the target video based on the image dressing result of the front image, the at least one key image, the skeleton extraction result of each frame image in the target video, the background extraction result of each frame image in the target video, and a body position recognition result (such as a mask image for occluding a body) of each frame image in the target video, so that a body position of the object may be learned based on the body position recognition results during the generation of the video dressing result, thereby ensuring that the finally generated video dressing result may at least satisfy a position constraint indicated by the body position recognition results. This helps better improve the dressing effect.

It may be learned that in a possible implementation, when S3 is implemented by using a pre-built DIT having a function of generating a video under the guidance of a plurality of conditions, S3 may specifically include: inputting the image dressing result of the front image, the at least one key image, the skeleton extraction result (the skeleton image shown in FIG. 5) of each frame image in the target video, the background extraction result (the background protection image shown in FIG. 5) of each frame image in the target video, the body position recognition result (the mask image shown in FIG. 5) of each frame image in the target video, and the text (text prompt 2 shown in FIG. 5) that may indicate the user requirement into the DIT, so that the DIT may perform video generation (such as generation processing similar to that shown in FIG. 5) under the guidance of the input data, to obtain and output the video dressing result of the target video, so that the video dressing result may satisfy as much as possible the constraints indicated by the input data. This helps better improve the dressing effect.

For an ith image in the target video, the body position recognition result of the ith image is obtained by performing recognition processing on a body of the object in the ith image, so that the body position recognition result may represent a position of the body of the object in the ith image, where i is a positive integer, and i is less than or equal to the number of images in the target video.

In addition, the present application does not limit an implementation of the body position recognition result, for example, the body position recognition result may be implemented by using an image (the mask image shown in FIG. 4 or FIG. 5).

In addition, the present application does not limit a manner of obtaining the body position recognition result, for example, the body position recognition result may be implemented by using any method that may recognize a body position from an image, such as any body position detection algorithm (such as a target detection algorithm) or a machine learning model with a body position detection function. It should be noted that the present application does not limit an implementation of the machine learning model.

It is found through research that in some scenarios, if the clothes image only indicates clothes (such as a top or pants) that need to be worn by part of a body, in order to better improve generation efficiency, only the part of the body may be generated during the dressing processing.

Based on the above research, in a possible implementation, in order to better improve the quality of the dressing video, when the clothes image indicates clothes suitable to be worn on a target part (such as an upper body), S3 may include: generating the video dressing result of the target video based on the image dressing result of the front image, the at least one key image, the skeleton extraction result of each frame image in the target video, the background extraction result of each frame image in the target video, and a target part position recognition result (such as a mask image for occluding the target part) of each frame image in the target video, to ensure that only the target part needs to satisfy the clothes constraint (such as the clothes constraint described in the image dressing result) indicated by the clothes image during the generation of the video dressing result. This helps better improve the dressing effect.

It may be learned that in a possible implementation, when the clothes image indicates the clothes suitable to be worn on the target part, and S3 is implemented by using a pre-built DIT having a function of generating a video under the guidance of a plurality of conditions, S3 may specifically include: inputting the image dressing result of the front image, the at least one key image, the skeleton extraction result of each frame image in the target video, the background extraction result of each frame image in the target video, the target part position recognition result of each frame image in the target video, and a text that may indicate a user requirement into the DIT, so that the DIT may perform video generation under the guidance of the input data, to obtain and output the video dressing result of the target video, so that the video dressing result may satisfy as much as possible constraints indicated by the input data. This helps better improve the dressing effect.

It is found through research that for a same piece of clothing, if postures or shooting view angles of an object that wears the piece of clothing are different, details (such as texture and grain details) presented by the object in an image may be different.

Based on the above research, in order to better improve the dressing effect, the present application provides a possible implementation of the video generation method. In this implementation, the video generation method may include at least the following steps: obtaining an image dressing result of each of the at least one key image, so that each image dressing result may describe a state of the object in each key image in the clothes indicated by the clothes image, so that these image dressing results may supplement details (such as details about features presented by the clothes in different postures) lacking in the image dressing result of the front image; and generating the video dressing result of the target video based on the image dressing result of the front image, the image dressing result of each key image, and the skeleton extraction result of each frame image in the target video, so that the video dressing result may better describe states presented by the object that wears the clothes in different cases (such as different postures, different view angles, different backgrounds, and different light), thereby helping improve the dressing effect.

It may be learned that in a possible implementation, when S3 is implemented by using a pre-built DIT (model 2 shown in FIG. 5) having a function of generating a video under the guidance of a plurality of conditions, S3 may specifically include: inputting the image dressing result of the front image, the image dressing result of each of the at least one key image, the skeleton extraction result (the skeleton image shown in FIG. 5) of each frame image in the target video, the background extraction result (the background protection image shown in FIG. 5) of each frame image in the target video, the body position recognition result (the mask image shown in FIG. 5) of each frame image in the target video, and a text (text prompt 2 shown in FIG. 5) that may indicate a user requirement into the DIT, so that the DIT may perform video generation (generation processing shown in FIG. 5) under the guidance of the input data, to obtain and output the video dressing result of the target video, so that the video dressing result may satisfy as much as possible the constraints indicated by the input data. This helps significantly improve the quality of video generation in various cases (such as a case of a large-scale motion of the object in the target video), and in particular, present a good effect in terms of texture stability and material realness, thereby helping better improve the dressing effect.

It should be noted that, for model 2 shown in FIG. 5, model 2 is a DIT model that may perform generation processing based on a plurality of conditions; and a text encoder (Tokenizer) in model 2 is configured to process a text in input data of model 2 to obtain an encoding result of the text, so that the encoding result may represent information (such as semantic information) carried by the text; an image encoder in model 2, for example, an encoding module (Encoder) in a variational autoencoder (Variational auto-encoder, VAE) is configured to process an image in the input data of model 2 to obtain an encoding result of the image; a splitting module (Patchfy) in model 2 is configured to split the encoding result of the image into encoding results of a plurality of image blocks; N triple multimodal diffusion transformer blocks (Triple Multimodal Diffusion Transformer Block) in model 2 are configured to process output data of the splitting module, where N is a positive integer; a merging module (Unpatch) in model 2 is configured to merge output data of the N triple multimodal diffusion transformer blocks; and an image decoder in model 2, for example, a decoding module (Decoder) in the VAE is configured to decode output data of the merging module to obtain a final generated video.

An image dressing result of a kth key image is obtained by performing dressing processing on the kth key image, so that the image dressing result may represent a state presented after an object in the kth key image is replaced from clothes that the object has been wearing to the clothes indicated by the clothes image, thereby enabling clothes of the object in the image dressing result to be consistent with the clothes indicated by the clothes image, where k is a positive integer, and k is less than or equal to the number of images in the at least one key image. It should be noted that the present application does not limit a manner of obtaining the image dressing result.

It is found through research that in some scenarios, for any key image, a difference between the image dressing result of the key image and the image dressing result of the front image may include: a different object posture and/or a different background.

Based on the above research, in order to better improve efficiency, the step of "obtaining an image dressing result of each of the at least one key image" may include: for any key image of the at least one key image, generating the image dressing result of the key image based on the image dressing result of the front image, a skeleton extraction result of the key image, and a background extraction result of the key image, so that the image dressing result of the key image is obtained by performing adjustment processing on the image dressing result of the front image according to a skeleton constraint (such as a constraint in terms of a posture and/or a view angle) indicated by the skeleton extraction result and a background constraint indicated by the background extraction result, thereby enabling the image dressing result of the key image to satisfy at least the following constraints: an object in the image dressing result is consistent with the key image in terms of a skeleton, a background in the image dressing result is consistent with a background in the key image, and clothes of the object in the image dressing result satisfy a clothes constraint indicated by the image dressing result of the front image. In this way, the image dressing result of each key image may be obtained by adjusting the image dressing result of the front image, thereby helping better improve the dressing effect.

It should be noted that the present application does not limit an implementation of the solution in the above paragraph, for example, the solution may be implemented by using any machine learning model that may perform image generation based on a plurality of conditions (such as the image dressing result of the front image, the skeleton extraction result of the key image, and the background extraction result of the key image), such as a DIT.

It is found through research that in some scenarios, the change indicated by the at least one key image is in a continuous state. Therefore, in order to better improve the dressing effect, the at least one key image may be used as a whole (for example, as a video) for dressing processing (such as video dressing processing), so that a correlation between the key images may be fully utilized during the dressing processing.

It may be learned based on the above research that in a possible implementation, the step of "obtaining an image dressing result of each of the at least one key image" may include: performing video generation processing based on the image dressing result of the front image, a skeleton extraction result of each image in the at least one key image, and a background extraction result of each image in the at least one key image, to obtain the image dressing result of each image in the at least one key image. In this way, the image dressing result of each key image may be obtained in a same generation process. The image dressing result of each key image is obtained with reference to not only some information carried by the key image, but also information carried by another key image, so that the quality of the finally generated image dressing result of each key image is better, thereby enabling the dressing video generated under the guidance of the image dressing result of each key image to be better, and further helping improve the dressing effect.

It should be noted that the present application does not limit an implementation of the solution in the above paragraph, for example, the solution may be implemented by using any machine learning model that may perform video generation based on a plurality of conditions (such as the image dressing result of the front image, the skeleton extraction result of the key image, and the background extraction result of the key image), such as a DIT.

It may be learned that in a possible implementation, a process of determining the image dressing result of each key image in the at least one key image may include: inputting the image dressing result of the front image, the skeleton extraction result (the skeleton image shown in FIG. 4) of each key image in the at least one key image, the background extraction result (the background protection image shown in FIG. 4) of each key image in the at least one key image, the body position recognition result (the mask image shown in FIG. 4) of each key image in the at least one key image, and a text (text prompt 1 shown in FIG. 4) that may indicate a user requirement into the DIT, so that the DIT (model 1 shown in FIG. 4) may perform generation processing (such as video generation processing) by using the input data as conditions, to obtain and output the image dressing result of each key image in the at least one key image. In this way, the image dressing result of each key image may be better synthesized based on the image dressing result of the front image, so that the dressing video generated under the guidance of the image dressing result of each key image is better, thereby helping improve the dressing effect.

It should be noted that, for model 1 shown in FIG. 4, model 1 is a DIT model that may perform generation processing based on a plurality of conditions; and a text encoder (Tokenizer) in model 1 processes a text in input data of model 1 to obtain an encoding result of the text, so that the encoding result may represent information (such as semantic information) carried by the text; an image encoder (such as a VAE Encoder) in model 1 is configured to process an image in the input data of model 1 to obtain an encoding result of the image; a splitting module (Patchfy) in model 1 is configured to split the encoding result of the image into encoding results of a plurality of image blocks; N triple multimodal diffusion transformer blocks (Triple Multimodal Diffusion Transformer Block) in model 1 are configured to process output data of the splitting module, where N is a positive integer; a merging module (Unpatch) in model 1 is configured to merge output data of the N triple multimodal diffusion transformer blocks; and an image decoder (such as a VAE Decoder) in model 1 is configured to decode output data of the merging module to obtain final generation data (such as an image or a video).

It is found through research that some clothes have relatively complex styles, so that the clothes present different features in different view angles (for example, a front side of the clothes has a cartoon character, but a back side of the clothes has a big tree and other different features).

Based on the above research, in order to better improve the dressing effect, the present application provides a possible implementation of the video generation method. In this implementation, the video generation method may include at least the following steps: obtaining a plurality of clothes images, where the plurality of clothes images all indicate a same piece of clothing, and different images in the plurality of clothes images indicate different view angles, so that the plurality of clothes images may describe features of the same piece of clothing in different view angles; and generating the image dressing result of the front image based on the front image and a clothes image that is included in the plurality of clothes images and that matches a view angle indicated by the front image, and generating the image dressing result of each of the at least one key image based on the plurality of clothes images and the at least one key image. In this way, the image dressing results of different images may be generated by using the features of the same piece of clothing in a plurality of view angles as conditions, thereby ensuring that the image dressing results may better show the features of the piece of clothing in each of the view angles, and further helping better improve the dressing effect.

It should be noted that the present application does not limit a process of determining the "image dressing result of the front image" shown in the above paragraph, for example, the process may specifically be: after the plurality of clothes images are obtained, first calculating a degree of adaptation between the view angle indicated by the front image and a view angle indicated by each of the plurality of clothes images, so that the degree of adaptation may represent whether the front image matches each clothes image; then determining a clothes image with a highest degree of adaptation that is included in the plurality of clothes images as the clothes image (such as a clothes image closest to a front view angle) that matches the view angle indicated by the front image; and then, performing dressing processing on the front image according to the clothes image that matches the view angle indicated by the front image, to obtain the image dressing result of the front image, so that the image dressing result may describe a state presented by the object in the front image after wearing the clothes indicated by the clothes image that matches the view angle indicated by the front image. The "view angle indicated by the front image" refers to a shooting view angle used when the object is shot by using a camera, so that the "view angle indicated by the front image" may reflect, to some extent, a shooting view angle of the clothes worn by the object in the front image, thereby enabling the image dressing result of the front image generated by using the clothes image that matches the "view angle indicated by the front image" as a condition to be more accurate. In addition, for any clothes image, the view angle indicated by the clothes image refers to a shooting view angle used when the clothes indicated by the clothes image are shot by using a camera. In addition, the present application does not limit an implementation of the matching, for example, the matching may refer to being the same or very close (for example, a difference between two view angles is less than a preset difference threshold).

It should be further noted that the present application does not limit a manner of obtaining the plurality of clothes images, for example, the plurality of clothes images may be specifically obtained by shooting a same piece of clothing in different view angles.

It should be further noted that the present application does not limit an implementation of the step of "generating the image dressing result of each of the at least one key image based on the plurality of clothes images and the at least one key image", for example, the step may be implemented by using a pre-built machine learning model having an image dressing function; and the present application does not limit an implementation of the machine learning model.

In addition, in some scenarios, if the shooting view angle of the plurality of clothes images is consistent with the view angle indicated by the at least one key image, in order to better improve efficiency, the process of determining the image dressing result of each key image in the at least one key image may include: for any key image of the at least one key image, in response to there being a clothes image, which is included in the plurality of clothes images and whose view angle matches a view angle indicated by the key image, generating the image dressing result of the key image based on the key image and the clothes image “whose view angle matches the view angle indicated by the key image”. In this way, the image dressing result of each key image may be obtained by using image dressing processing with low time consumption, thereby helping improve efficiency.

It should be noted that the present application does not limit an implementation of the solution in the above paragraph, for example, the solution may specifically be: for any key image of the at least one key image, if it is detected that there is a clothes image, which is included in the plurality of clothes images and whose view angle matches the view angle indicated by the key image, performing dressing processing (similar to the dressing processing shown in S2) on the key image according to the clothes image whose view angle matches the view angle indicated by the key image, to obtain the image dressing result of the key image.

It should be further noted that related content of the view angle indicated by the key image is similar to related content of the "view angle indicated by the front image", and for the sake of brevity, details are not described herein again.

It is found through research that it may be relatively difficult to obtain the plurality of clothes shown in the above three paragraphs, which increases the difficulty of the dressing processing. Therefore, in order to better reduce the difficulty, the process of determining the image dressing result of each key image in the at least one key image may include: in response to there being a difference between a view angle indicated by the plurality of clothes images and the view angle indicated by the at least one key image, for any clothes image, other than the clothes image “whose view angle matches the view angle indicated by the front image”, of the plurality of clothes images, generating an image dressing result corresponding to the clothes image based on the clothes image and an image, which is included in the target video and whose view angle matches a view angle indicated by the clothes image, so that the image dressing results corresponding to these clothes images may represent effects of the clothes being worn in different view angles; and for any key image of the at least one key image, generating the image dressing result of the key image based on image dressing results corresponding to each clothes image, other than the clothes image “whose view angle matches the view angle indicated by the front image”, of the plurality of clothes images, the image dressing result of the front image, a skeleton extraction result of the key image, and a background extraction result of the key image. In this way, the generation process of the image dressing result of each key image may refer to the effects of the clothes being worn in a plurality of view angles, so that the finally generated image dressing result of each key image may be more accurate, thereby enabling the dressing video generated based on the image dressing result of each key image to better describe the features of the clothes indicated by the plurality of clothes images. This may effectively overcome a problem caused by the difference between the view angle indicated by the plurality of clothes images and the view angle indicated by the at least one key image, thereby helping improve the dressing effect.

It should be noted that the present application does not limit a manner of generating the image dressing result of each key image in the above paragraph, for example, the image dressing result may be generated by using any machine learning model that may perform image generation based on a plurality of conditions, such as a DIT.

In addition, in some scenarios, in order to better improve the dressing effect, a process of generating the image dressing result of each key image in the at least one key image may include: performing video generation processing (for example, generation processing similar to that shown in FIG. 4) based on the image dressing results corresponding to each clothes image, other than the clothes image “whose view angle matches the view angle indicated by the front image”, of the plurality of clothes images, the image dressing result of the front image, a skeleton extraction result of each key image in the at least one key image, and a background extraction result of each key image in the at least one key image, to obtain the image dressing result of each key image in the at least one key image. In this way, the image dressing results of all the key images may be obtained in one generation process. The image dressing result of each key image is obtained with reference to not only some information carried by the key image, but also information carried by another key image, so that the quality of the finally generated image dressing result of each key image is better, thereby enabling the dressing video generated under the guidance of the image dressing result of each key image to be better, and further helping improve the dressing effect.

It may be learned that in a possible implementation, the process of determining the image dressing result of each key image in the at least one key image may include: inputting the image dressing results corresponding to each clothes image, other than the clothes image “whose view angle matches the view angle indicated by the front image”, of the plurality of clothes images, the image dressing result of the front image, the skeleton extraction result of each key image in the at least one key image, the background extraction result of each key image in the at least one key image, the body position recognition result of each key image in the at least one key image, and a text that may indicate a user requirement into the DIT, so that the DIT may perform generation processing (such as video generation processing) by using the input data as conditions, to obtain and output the image dressing result of each key image in the at least one key image. In this way, the image dressing result of each key image may be better synthesized under the guidance of the image dressing results of a plurality of frames of images in the target video, so that the dressing video generated under the guidance of the image dressing result of each key image is better, thereby helping improve the dressing effect.

In addition, in some scenarios, in order to take into account both efficiency and video quality, the process of generating the image dressing result of each key image in the at least one key image may include: for any key image of the at least one key image, if there is a clothes image, which is included in the plurality of clothes images and whose view angle matches a view angle indicated by the key image, generating the image dressing result of the key image based on the key image and the clothes image “whose view angle matches the view angle indicated by the key image”; or if there is no clothes image, which is included in the plurality of clothes images and whose view angle matches the view angle indicated by the key image, generating the image dressing result of the key image based on the image dressing results corresponding to each clothes image, other than the clothes image “whose view angle matches the view angle indicated by the front image”, of the plurality of clothes images, the image dressing result of the front image, a skeleton extraction result of the key image, and a background extraction result of the key image.

It should be noted that, in the second case shown in the above paragraph, in order to better improve the dressing effect, all key images for which a matching clothes image cannot be found may be used as a whole for video dressing processing (for example, generation processing similar to that shown in FIG. 4), to obtain the image dressing results of these key images.

It is found through research that in some scenarios, a user may not directly provide a flat image of a certain piece of clothing, but provide a worn image of the piece of clothing. The worn image carries not only description information of the piece of clothing, but also description information of a certain object, so that information, other than the description information of the piece of clothing, carried by the worn image easily interferes with dressing processing, affecting a dressing effect.

Based on the above research, in order to better improve the dressing effect, the present application further provides a process of obtaining the clothes image, and the process may specifically include: obtaining a target image (such as a worn image), where clothes of an object in the target image are different from clothes of an object in the target video; and determining the clothes image based on a clothes extraction result of the target image, so that the clothes image is a flat image of the clothes worn by the object in the target image. Therefore, the piece of clothing may be better described in the clothes image, and the dressing video generated under the guidance of the clothes image will not be interfered with by the information, other than the description information of the piece of clothing, carried by the target image. This helps improve the dressing effect.

It should be noted that the clothes extraction result of the target image refers to an image obtained by performing clothes extraction processing on the target image; and the present application does not limit a manner of obtaining the clothes extraction result, for example, the clothes extraction result may be implemented by using any method that may extract a clothes image from an image, such as a machine learning model with a clothes extraction function. In addition, the present application does not limit an implementation of the machine learning model.

It should be further noted that the present application does not limit a manner of obtaining the target image, for example, the target image may be provided by a user by using some input devices. For another example, the target image may be provided by another data processing task that has been completed or is being performed on a current device (such as an execution device of the above video generation method).

In addition, in order to better improve efficiency, the present application further provides a process of obtaining the clothes image, and the process may specifically include: first obtaining a target image (such as a worn image), where clothes of an object in the target image are different from clothes of an object in the target video; then determining whether the object in the target image and the object in the target video are a same object; if yes, using the target image as the clothes image; if no, determining a clothes extraction result of the target image as the clothes image. In this way, time consumption for obtaining the clothes image may be reduced as much as possible while ensuring the dressing effect.

In addition, in order to better improve flexibility, the present application further provides a process of obtaining the front image, and the process may specifically include: obtaining a reference skeleton indicating a front view angle; and determining the front image from the target video based on a similarity between the reference skeleton and a skeleton extraction result of each frame image in the target video, so that a similarity between the reference skeleton and a skeleton extraction result of the front image is not lower than (higher than or equal to) a similarity between the reference skeleton and a skeleton extraction result of each of other frame images, other than the front image, in the target video. Therefore, the front image may represent an image that is included in the target video and that is closest to body features (such as a posture and/or a view angle) indicated by the reference skeleton. In this way, the front image may be automatically selected from the target video, thereby helping reduce difficulty in obtaining the front image and improve flexibility in obtaining the front image.

It should be noted that the present application does not limit an implementation of the solution in the above paragraph, for example, the solution may specifically include: after the similarity between the reference skeleton and the skeleton extraction result of each frame image in the target video is obtained, sorting all images in the target video in ascending order (for example, sorting from the minimum similarity to the maximum similarity) of the similarity, to obtain a sorting result, so that a similarity between the reference skeleton and a skeleton extraction result of an image in a last sorting position in the sorting result is the maximum; and using the image in the last sorting position as the front image that has a smallest difference from the reference skeleton.

It should be further noted that the reference skeleton refers to a preset skeleton image that may indicate features of the front image, so that the reference skeleton may indicate a selection condition (such as a selection condition in a posture and/or a view angle) of the front image. It may be learned that in a possible implementation, the reference skeleton may at least indicate a front view angle and/or a preset posture (such as a standing posture, a T posture, or a Y posture), so as to be able to select a front image from any video based on the front view angle and/or the preset posture subsequently. In addition, the present application does not limit a manner of obtaining the reference skeleton, for example, the reference skeleton may be provided by a related person in a labeling manner. For another example, the reference skeleton may be obtained by performing skeleton extraction processing on a front image included in another video.

It should be further noted that for any image in the target video, the similarity between the reference skeleton and the skeleton extraction result of the image may represent a similarity degree between a body state of an object in the image and a body state described by the reference skeleton; and the present application does not limit a manner of obtaining the similarity, for example, the similarity may be specifically obtained by: performing image similarity evaluation processing on the skeleton extraction result of the image and the reference skeleton, to obtain the similarity between the skeleton extraction result of the image and the reference skeleton. The image similarity evaluation processing is used for evaluating a similarity degree between any two images; and the present application does not limit an implementation of the image similarity evaluation processing, for example, the image similarity evaluation processing may be implemented by using any method that may evaluate a similarity degree between two images, such as a machine learning model with an image similarity evaluation function. The present application does not limit an implementation of the machine learning model.

In addition, in order to better improve an evaluation effect, for any image in the target video, a process of determining the similarity between the reference skeleton and the skeleton extraction result of the image may include: determining the similarity between the skeleton extraction result of the image and the reference skeleton based on a skeleton orientation angle determined from the skeleton extraction result of the image and a skeleton orientation angle determined from the reference skeleton, so that the similarity may indicate a similarity degree between the skeleton orientation angle determined from the skeleton extraction result of the image and the skeleton orientation angle determined from the reference skeleton, thereby enabling the similarity to better represent whether the body state of the object in the image is similar to the body state described by the reference skeleton.

It should be noted that for any skeleton image (such as the above skeleton extraction result, the above reference skeleton, or the skeleton image shown in FIG. 3), the skeleton orientation angle determined from the skeleton image may represent body state features indicated by the skeleton image; and the present application does not limit an implementation of the skeleton orientation angle, for example, the skeleton orientation angle may include: an orientation angle indicated by a position vector between a left shoulder point and a neck point, and an orientation angle indicated by a position vector between a right shoulder point and a neck point. For another example, the skeleton orientation angle may further include: an orientation angle indicated by a position vector between the left shoulder point and a left elbow point, and an orientation angle indicated by a position vector between the right shoulder point and a right elbow point. It may be learned that in a possible implementation, the skeleton orientation angle determined from the skeleton may be implemented by using an orientation angle sequence.

In addition, in order to better improve flexibility, the present application further provides a process of obtaining the at least one key image, and the process may specifically include the following steps 11 to 13.

Step 11: obtaining a reference skeleton indicating a front view angle.

It should be noted that for related content of step 11, please refer to the above.

Step 12: selecting a first image from the target video based on a similarity between the reference skeleton and a skeleton extraction result of each frame image in the target video, a similarity between the reference skeleton and a skeleton extraction result of the first image being not higher than (lower than or equal to) a similarity between the reference skeleton and a skeleton extraction result of each of other frame images, other than the first image, in the target video, so that the first image may represent an image that is included in the target video and that has a largest number of differences from body features (such as a posture and/or a view angle) indicated by the reference skeleton. In this way, the first image that has a largest difference from the front image may be automatically selected from the target video.

It should be noted that the present application does not limit an implementation of step 12, for example, step 12 may be specifically: after the similarity between the reference skeleton and the skeleton extraction result of each frame image in the target video is obtained, sorting all images in the target video in ascending order (for example, sorting from the minimum similarity to the maximum similarity) of the similarity, to obtain a sorting result, so that a similarity between the reference skeleton and a skeleton extraction result of an image in a first sorting position in the sorting result is the minimum; and using the image in the first sorting position as the first image that has a largest difference from the reference skeleton.

Step 13: determining the at least one key image based on the first image, so that the at least one key image includes the first image.

It should be noted that the present application does not limit an implementation of step 13, for example, step 13 may be specifically: using the first image as the at least one key image.

It may be learned based on related content of steps 11 to 13 that in some scenarios, such as when there are low requirements on video quality, the image that is included in the target video and that has a largest difference from the reference skeleton may be used as the at least one key image, so that the at least one key image may supplement as much detail information as possible that cannot be described by the front image having a smallest difference from the reference skeleton, thereby enabling the dressing video generated under the guidance of the key image and the front image to be better, and further helping improve the dressing effect.

In addition, in some scenarios, such as when there are relatively high requirements on video quality, in order to better improve the dressing effect, the present application further provides a possible implementation of the process of obtaining the at least one key image. In this implementation, the obtaining process includes not only steps 11 to 13, but may further include the following steps 14 and 15. An execution time of step 14 is later than an execution time of step 13.

Step 14: selecting a second image from a difference set between the target video and the at least one key image, a similarity between a skeleton extraction result of the second image and a skeleton extraction result of each of the at least one key image being less than a preset threshold.

The difference set between the target video and the at least one key image may indicate all other images, other than the at least one key image, that are included in the target video.

The second image refers to a frame of image selected from the difference set, so that the similarity between the skeleton extraction result of the second image and the skeleton extraction result of each of the at least one key image is less than the preset threshold, thereby enabling the second image to represent an image that is included in the difference set and that has a relatively large difference from each of the at least one key image in terms of a skeleton.

It should be noted that the present application does not limit a manner of obtaining the preset threshold, for example, the preset threshold may be set based on a current application scenario, so that the preset threshold satisfies a requirement in the application scenario.

In addition, in order to better improve flexibility, a process of determining the preset threshold may include: first calculating an average value of similarities between the reference skeleton and the skeleton extraction result of each frame image in the target video, so that the average value may represent an average similarity between each frame image in the target video and the reference skeleton; and then determining the preset threshold based on the average value, so that the preset threshold may better indicate a minimum value of differences between different key images, thereby enabling the key images selected based on the preset threshold to provide as much supplementary information as possible, and further enabling the dressing video generated under the guidance of these key images to be better. This helps improve the dressing effect.

It should be noted that the present application does not limit the process of determining the average value in the above paragraph, for example, when the target video includes M frame images, and M is a positive integer, the process of determining the average value may include: summing a similarity between the reference skeleton and a skeleton extraction result of a first frame image in the target video, a similarity between the reference skeleton and a skeleton extraction result of a second frame image in the target video, ... (and so on), and a similarity between the reference skeleton and a skeleton extraction result of an Mth frame image in the target video, to obtain a sum; and dividing the sum by M to obtain the average value.

It should be further noted that the present application does not limit the implementation of the step of "determining the preset threshold based on the average value", for example, the step may be specifically: determining a product of the average value and a preset coefficient (such as 0.2) as the preset threshold.

Step 15: updating the at least one key image based on the second image, the at least one updated key image including the second image, and returning to step 14 and subsequent steps.

It should be noted that the present application does not limit an implementation of step 15, for example, step 15 may be specifically: adding the second image to the at least one key image.

For another example, in some scenarios, step 15 may be specifically: updating the at least one key image based on the second image, the at least one updated key image including the second image, and returning to step 14 and subsequent steps, until it is determined that there is no second image in the difference set between the target video and the at least one key image, it is determined that an image that has a relatively large difference from each image in the at least one key image cannot be selected from the target video, and therefore the iterative loop process may be directly ended.

For another example, in some scenarios, step 15 may be specifically: updating the at least one key image based on the second image, the at least one updated key image including the second image, and returning to step 14 and subsequent steps, until it is determined that the number of images in the at least one key image reaches a predetermined number threshold, the iterative loop process is directly ended.

It may be learned based on related content of steps 11 to 15 that in some scenarios, such as when there are relatively high requirements on video quality, the image (such as the first image) that is included in the target video and that has a largest difference from the reference skeleton may first be used to initialize the at least one key image, so that the at least one initialized key image includes the image having the largest difference. Then, the at least one key image is updated with the image (such as the second image) that is selected from the target video and that has a relatively large difference from each image in the at least one key image, so that the at least one updated key image includes the "image that has a relatively large difference from each image in the at least one key image". Based on the at least one updated key image, the method returns to the step of "updating the at least one key image with the image (such as the second image) that is selected from the target video and that has a relatively large difference from each image in the at least one key image" and subsequent steps, to implement a next round of processing. This is iteratively performed until it is determined that a preset stop condition (for example, the number of images in the at least one key image reaches a predetermined number threshold, or an image that has a relatively large difference from each image in the at least one key image cannot be selected from the target video) is met, and then the iterative loop ends. In this way, some images with relatively large differences may be automatically selected from the target video as key images in a plurality of rounds of iterative loops, so that these key images may provide as much supplementary information as possible, thereby enabling the dressing video generated under the guidance of these key images to be better. This helps improve the dressing effect.

It is found through research that in some scenarios, such as a scenario in which the preset threshold is inappropriately selected or a scenario with a relatively high efficiency requirement, the present application further provides a possible implementation of the process of obtaining the at least one key image. In this implementation, the obtaining process includes not only steps 11 to 15, but may further include the following steps 16 and 17. An execution time of step 16 is later than an execution time of step 15.

Step 16: in response to the number of images in the at least one key image exceeding a preset number (three shown in FIG. 2), for any image in the at least one key image, summing similarities between a skeleton extraction result of the image and skeleton extraction results of each of other images than the image, in the at least one key image to obtain a sum corresponding to the image, so that the sum may represent a difference between the image and all other images than the image, in the at least one key image.

It should be noted that the present application does not limit a calculation manner of the sum, for example, when the number of images in the at least one key image is 10, a process of determining a sum corresponding to a first key image in the at least one key image includes: summing a similarity between the skeleton extraction result of the first key image and a skeleton extraction result of a second key image in the at least one key image, a similarity between the skeleton extraction result of the first key image and a skeleton extraction result of a third key image in the at least one key image, ... (and so on), and a similarity between the skeleton extraction result of the first key image and a skeleton extraction result of a tenth key image in the at least one key image, to obtain the sum corresponding to the first key image, so that the sum may represent a difference between the first key image and all other images, other than the first key image, in the at least one key image. If the sum is greater, it indicates that the difference between the first key image and all other images, other than the first key image, in the at least one key image is smaller. However, if the sum is smaller, it indicates that the difference between the first key image and all other images, other than the first key image, in the at least one key image is greater.

Step 17: deleting a third image satisfying a condition (such as a key image corresponding to a relatively large sum) from the at least one key image based on the sum corresponding to each image in the at least one key image, so that a sum corresponding to each image in at least one remaining key image (three key images with largest differences shown in FIG. 2) is not greater than a sum corresponding to the third image, and the number of images in the at least one remaining key image is a preset number. In this way, the at least one remaining key image may represent a key image that is included in the at least one key image before deletion and that corresponds to a relatively small sum, thereby enabling the at least one remaining key image to represent images that are included in the target video and that have relatively large differences from each other. Therefore, the at least one remaining key image may provide as much supplementary information as possible with a minimum number of images, thereby enabling the dressing video generated under the guidance of these key images to be better, and further helping better improve the dressing effect.

It may be learned based on related content of steps 11 to 17 that in some scenarios, after some key images are obtained through an iterative loop, images with relatively large differences (such as the at least one remaining key image or the three key images with the largest differences shown in FIG. 2) may be selected from these key images to participate in subsequent dressing processing, such as generation processing shown in FIG. 4 and generation processing shown in FIG. 5. In this way, efficiency may be improved on the premise that the quality of dressing video generation is ensured as much as possible, thereby helping better improve the dressing effect.

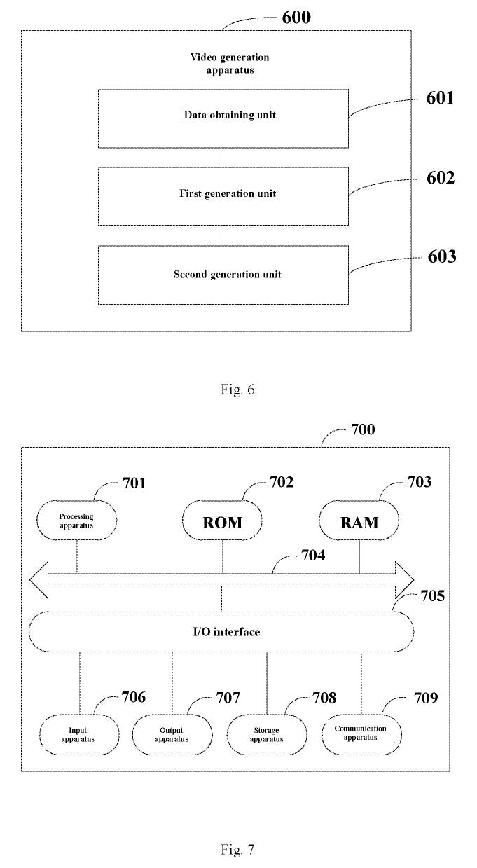

Based on the video generation method provided by the embodiment of the present application, an embodiment of the present application further provides a video generation apparatus, which will be explained and described below with reference to FIG. 6. FIG. 6 is a schematic diagram of a structure of a video generation apparatus according to an embodiment of the present application. For technical details of the video generation apparatus provided by the embodiment of the present application, refer to related content of the video generation method above.

As shown in FIG. 6, the video generation apparatus 600 provided by the embodiment of the present application includes:

a data obtaining unit 601, configured to obtain a clothes image, a target video, a front image in the target video, and at least one key image in the target video, where the front image describes a state of an object in the target video in a front view angle, each of the at least one key image has a difference from the front image in at least one dimension, and the at least one dimension includes a posture and/or a view angle;

a first generation unit 602, configured to generate an image dressing result of the front image based on the clothes image and the front image; and

a second generation unit 603, configured to generate a video dressing result of the target video based on the image dressing result, the at least one key image, and a skeleton extraction result of each frame image in the target video.

In a possible implementation, the second generation unit 603 is further configured to generate the video dressing result of the target video based on the image dressing result, the at least one key image, the skeleton extraction result of each frame image in the target video, and a background extraction result of each frame image in the target video.

In a possible implementation, the video generation apparatus 600 further includes:

a result obtaining unit, configured to obtain an image dressing result of each of the at least one key image,

and the second generation unit 603 is further configured to generate the video dressing result of the target video based on the image dressing result of the front image, the image dressing result of each of the at least one key image, and the skeleton extraction result of each frame image in the target video.

In a possible implementation, the result obtaining unit is further configured to: for any key image of the at least one key image, generate an image dressing result of the key image based on the image dressing result of the front image, a skeleton extraction result of the key image, and a background extraction result of the key image.

In a possible implementation, the data obtaining unit 601 is further configured to: obtain a plurality of clothes images, where the plurality of clothes images all indicate a same piece of clothing, and different images in the plurality of clothes images indicate different view angles;

the first generation unit 602 is further configured to: generate the image dressing result of the front image based on the front image and a clothes image, which is included in the plurality of clothes images and whose view angle matches a view angle indicated by the front image; and

the result obtaining unit is further configured to: generate the image dressing result of each of the at least one key image based on the plurality of clothes images and the at least one key image.

In a possible implementation, the result obtaining unit is further configured to: for any key image of the at least one key image, in response to there being a clothes image, which is included in the plurality of clothes images and whose view angle matches a view angle indicated by the key image, generate the image dressing result of the key image based on the key image and the clothes image whose view angle matches the view angle indicated by the key image.

In a possible implementation, the result obtaining unit is further configured to: in response to there being a difference between a view angle indicated by the plurality of clothes images and a view angle indicated by the at least one key image, for any clothes image, other than the clothes image whose view angle matches the view angle indicated by the front image, of the plurality of clothes images, generate an image dressing result corresponding to the clothes image based on the clothes image and an image, which is included in the target video and whose view angle matches a view angle indicated by the clothes image; and for any key image of the at least one key image, generate the image dressing result of the key image based on image dressing results corresponding to each clothes image, other than the clothes image whose view angle matches the view angle indicated by the front image, of the plurality of clothes images, the image dressing result of the front image, a skeleton extraction result of the key image, and a background extraction result of the key image.

In a possible implementation, an obtaining process of the clothes image includes: obtaining a target image, where an object in the target image has different clothes from an object in the target video; and determining the clothes image based on a clothes extraction result of the target image.

In a possible implementation, an obtaining process of the front image includes: obtaining a reference skeleton indicating the front view angle; and determining the front image from the target video based on a similarity between the reference skeleton and a skeleton extraction result of each frame image in the target video, a similarity between the reference skeleton and a skeleton extraction result of the front image being not lower than a similarity between the reference skeleton and a skeleton extraction result of each of other frame images, other than the front image, in the target video.

In a possible implementation, an obtaining process of the at least one key image includes: obtaining a reference skeleton indicating the front view angle; selecting a first image from the target video based on a similarity between the reference skeleton and a skeleton extraction result of each frame image in the target video, a similarity between the reference skeleton and a skeleton extraction result of the first image being not higher than a similarity between the reference skeleton and a skeleton extraction result of each of other frame images, other than the first image, in the target video; and determining the at least one key image based on the first image, where the at least one key image includes the first image.

In a possible implementation, the obtaining process of the at least one key image further includes: after the determining the at least one key image based on the first image, selecting a second image from a difference set between the target video and the at least one key image, a similarity between a skeleton extraction result of the second image and a skeleton extraction result of each of the at least one key image being less than a preset threshold; and updating the at least one key image based on the second image, the at least one updated key image including the second image, and the step of selecting the second image from the difference set between the target video and the at least one key image being continuously performed.

In a possible implementation, the obtaining process of the at least one key image further includes: in response to the number of images in the at least one key image exceeding a preset number, for any image in the at least one key image, summing similarities between a skeleton extraction result of the image and skeleton extraction results of other images than the image, in the at least one key image to obtain a sum corresponding to the image; and deleting a third image satisfying a condition from the at least one key image based on the sum corresponding to each image in the at least one key image, a sum corresponding to each image in at least one remaining key image being not greater than a sum corresponding to the third image, and the number of images in the at least one remaining key image being the preset number.

In a possible implementation, a determining process of the preset threshold includes: calculating an average value of similarities between the reference skeleton and the skeleton extraction result of each frame image in the target video; and determining the preset threshold based on the average value.

In a possible implementation, for any image in the target video, the similarity between the reference skeleton and the skeleton extraction result of the image indicates a similarity degree between a skeleton orientation angle determined from the skeleton extraction result of the image and a skeleton orientation angle determined from the reference skeleton.

In a possible implementation, the at least one dimension includes some or all of the posture, the view angle, a background, and light.

It may be learned based on related content of the video generation apparatus 600 that the apparatus 600 works as follows: a clothes image, a target video, a front image in the target video, and at least one key image in the target video are obtained, so that the clothes image may indicate a clothes constraint that needs to be satisfied in dressing processing, an object in the target video has different clothes from clothes indicated by the clothes image, the front image may describe a state of the object in a front view angle, and each of the at least one key image has a difference from the front image in at least one dimension (such as a posture and/or a view angle). In this way, after an image dressing result of the front image is generated based on the clothes image and the front image, a video dressing result of the target video may be generated based on the image dressing result, the at least one key image, and a skeleton extraction result of each frame image in the target video. Clothes of an object in the image dressing result are consistent with the clothes indicated by the clothes image, so that the image dressing result may describe, in the front view angle, features presented by the object when wearing the clothes indicated by the clothes image. Therefore, clothes of an object in the video dressing result generated based on the image dressing result are also consistent with the clothes indicated by the clothes image. In this way, a dressing video may be automatically generated based on the clothes image. In addition, although the front image may describe some features of the object in the target video, the front image cannot comprehensively describe all features (such as posture motion features) of the object presented in the target video. In addition, each of the at least one key image has a difference from the front image in at least one dimension (such as a posture and/or a view angle), so that the at least one key image may provide some more detailed supplementary information (such as information about a state presented by the object during a large-scale motion) about the object described in the front image in these dimensions. Therefore, the features of the object described in the target video may be described as comprehensively as possible in combination with the at least one key image and the front image, so that enough features of the object may be obtained from the at least one key image and an image dressing result of the front image when the video dressing result is subsequently generated. In this way, the quality of video generation may be effectively improved, for example, the quality of video generation in the case of a large-scale motion of the object may be significantly improved.

In addition, an embodiment of the present application further provides an electronic device, including a processor and a memory, where the memory is configured to store an instruction or a computer program, and the processor is configured to execute the instruction or the computer program in the memory to cause the electronic device to perform any implementation of the video generation method provided by the embodiments of the present application.

Referring to FIG. 7, it shows a schematic structural diagram of an electronic device 700 suitable for implementing an embodiment of the present disclosure. The terminal device in the embodiments of the present disclosure may include, but is not limited to, mobile terminals such as a mobile phone, a notebook computer, a digital broadcast receiver, a personal digital assistant (PDA), a tablet computer (PAD), a portable multimedia player (PMP), and an in-vehicle terminal (for example, an in-vehicle navigation terminal), and fixed terminals such as a digital TV and a desktop computer. The electronic device shown in FIG. 7 is only an example, and should not impose any limitation to the function and scope of use of the embodiments of the present disclosure.

As shown in FIG. 7, the electronic device 700 may include a processing apparatus (e.g., a central processing unit, a graphics processing unit, etc.) 701, which may perform various appropriate actions and processing according to a program stored in a read-only memory (ROM) 702 or a program loaded into a random-access memory (RAM) 703 from a storage apparatus 708. In the RAM 703, various programs and data necessary for the operation of the electronic device 700 are also stored. The processing apparatus 701, the ROM 702, and the RAM 703 are connected to each other through a bus 704. An input/output (I/O) interface 705 is also connected to the bus 704.

Usually, the following apparatuses may be connected to the I/O interface 705: an input apparatus 706 including, for example, a touch screen, a touchpad, a keyboard, a mouse, a camera, a microphone, an accelerometer, and a gyroscope; an output apparatus 707 including, for example, a liquid crystal display (LCD), a speaker, and a vibrator; the storage apparatus 708 including, for example, a magnetic tape and a hard disk; and a communication apparatus 709. The communication apparatus 709 may allow the electronic device 700 to perform wireless or wired communication with other devices to exchange data. Although FIG. 7 shows the electronic device 700 having various apparatuses, it should be understood that it is not required to implement or provide all the apparatuses shown. More or fewer apparatuses may be implemented or provided alternatively.

In particular, according to an embodiment of the present disclosure, the process described above with reference to the flowchart may be implemented as a computer software program. For example, an embodiment of the present disclosure includes a computer program product, which includes a computer program carried on a non-transitory computer-readable medium, where the computer program contains program code for performing the method shown in the flowchart. In such an embodiment, the computer program may be downloaded and installed from a network via the communication apparatus 709, or installed from the storage apparatus 708, or installed from the ROM 702. When the computer program is executed by the processing apparatus 701, the functions defined in the method of the embodiment of the present disclosure are performed.

The electronic device provided by the embodiment of the present disclosure belongs to the same inventive concept as the method provided by the above embodiment, and for technical details not described in detail in this embodiment, reference may be made to the above embodiment, and this embodiment has the same beneficial effects as the above embodiment.

An embodiment of the present application further provides a computer-readable medium, where an instruction or a computer program is stored in the computer-readable medium, and the instruction or the computer program, when running on a device, causes the device to perform any implementation of the video generation method provided by the embodiments of the present application.

It should be noted that the computer-readable medium in the present disclosure may be a computer-readable signal medium, a computer-readable storage medium, or any combination thereof. The computer-readable storage medium may be, for example, but is not limited to, an electrical, magnetic, optical, electromagnetic, infrared, or semiconductor system, apparatus, or device, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated on a baseband or as a part of a carrier, and computer-readable program code is carried in the data signal. The data signal propagated in this way may be in multiple forms, and includes, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit a program for use by or in combination with an instruction execution system, apparatus, or device. The program code contained in the computer-readable medium may be transmitted in any suitable medium, including, but not limited to, a wire, an optical cable, a radio frequency (RF), or any suitable combination thereof.

In some implementations, a client and a server may communicate using any currently known or future developed network protocol, such as the hyper text transfer protocol (HTTP), and may be interconnected with any form or medium of digital data communication (for example, a communication network). Examples of the communication network include a local area network ("LAN"), a wide area network ("WAN"), an internet (for example, the Internet), a peer-to-peer network (for example, an Ad-Hoc network), and any network currently known or to be developed in the future.

The computer-readable medium may be contained in the electronic device, or may exist alone without being assembled into the electronic device.

The computer-readable medium carries one or more programs, and the one or more programs, when executed by the electronic device, cause the electronic device to perform the method described above.

The computer program code for performing the operations of the present disclosure may be written in one or more programming languages or a combination thereof, where the programming languages include, but are not limited to, an object-oriented programming language such as Java, Smalltalk, and C++, and further include conventional procedural programming languages such as "C" language or similar programming languages. The program code may be completely executed on a computer of a user, partially executed on a computer of a user, executed as an independent software package, partially executed on a computer of a user and partially executed on a remote computer, or completely executed on a remote computer or server. In the case of involving a remote computer, the remote computer may be connected to a computer of a user through any kind of network, including a local area network (LAN) or a wide area network (WAN), or may be connected to an external computer (for example, connected through the Internet with the aid of an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented in a software manner, and may also be implemented in a hardware manner. The name of the unit/module does not constitute a limitation on the unit itself under certain circumstances.

The functions described above may be at least partially performed by one or more hardware logic components. For example, without limitation, exemplary types of the hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of the machine-readable storage medium would include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

It should be noted that the embodiments in the specification are described in a progressive manner, each embodiment focuses on the difference from other embodiments, and the same and similar parts between the embodiments may be referred to each other. For the system or apparatus disclosed in the embodiments, since it corresponds to the method disclosed in the embodiments, the description is relatively simple, and for the related parts, reference may be made to the description of the method.

It should be understood that in the present application, "at least one item" means one or more, and "a plurality of" means two or more. "And/or" describes an association relationship between associated objects, and represents that three relationships may exist, for example, "A and/or B" may represent the three cases: only A exists, only B exists, and both A and B exist, where A and B may be singular or plural. The character "/" generally indicates an "or" relationship between the associated objects before and after it. "At least one of the following items (pieces)" or a similar expression thereof indicates any combination of these items, including a single item (piece) or any combination of a plurality of items (pieces). For example, at least one of a, b, or c may represent: a, b, c, "a and b", "a and c", "b and c", or "a, b, and c", where a, b, and c may be single or multiple.

It should also be noted that in this article, relational terms such as first and second are only used to distinguish one entity or operation from another entity or operation, and do not necessarily require or imply any actual relationship or order between these entities or operations. Moreover, the terms "include", "comprise", or any other variation thereof are intended to cover non-exclusive inclusion, so that a process, method, object, or device including a series of elements includes not only those elements, but also other elements not explicitly listed or elements inherent to such process, method, object, or device. Without further restrictions, an element defined by the phrase "including a" does not exclude that there are other identical elements in the process, method, object, or device including the element.

The steps of the method or algorithm described in conjunction with the embodiments disclosed herein may be directly implemented by hardware, a software module executed by a processor, or a combination thereof. The software module may be placed in a random access memory (RAM), a memory, a read-only memory (ROM), an electrically programmable ROM, an electrically erasable programmable ROM, a register, a hard disk, a removable magnetic disk, a CD-ROM, or any other form of storage medium known in the technical field.

The above description of the disclosed embodiments enables those skilled in the art to implement or use the present application. Various modifications to these embodiments will be obvious to those skilled in the art, and the general principles defined herein may be implemented in other embodiments without departing from the spirit or scope of the present application. Therefore, the present application will not be limited to the embodiments shown herein, but rather to the widest scope consistent with the principles and novel features disclosed herein.

1. A video generation method, comprising:
obtaining a clothes image, a target video, a front image in the target video, and at least one key image in the target video, wherein the front image describes a state of an object in the target video in a front view angle, each of the at least one key image has a difference from the front image in at least one dimension, and the at least one dimension comprises a posture and/or a view angle;
generating an image dressing result of the front image based on the clothes image and the front image; and
generating a video dressing result of the target video based on the image dressing result, the at least one key image, and a skeleton extraction result of each frame image in the target video.

2. The method of claim 1, wherein the generating the video dressing result of the target video based on the image dressing result, the at least one key image, and the skeleton extraction result of each frame image in the target video comprises:
generating the video dressing result of the target video based on the image dressing result, the at least one key image, the skeleton extraction result of each frame image in the target video, and a background extraction result of each frame image in the target video.

3. The method of claim 1, further comprising:
obtaining an image dressing result of each of the at least one key image,
wherein the generating the video dressing result of the target video based on the image dressing result, the at least one key image, and the skeleton extraction result of each frame image in the target video comprises:
generating the video dressing result of the target video based on the image dressing result of the front image, the image dressing result of each of the at least one key image, and the skeleton extraction result of each frame image in the target video.

4. The method of claim 3, wherein the obtaining the image dressing result of each of the at least one key image comprises:
for any key image of the at least one key image, generating an image dressing result of the key image based on the image dressing result of the front image, a skeleton extraction result of the key image, and a background extraction result of the key image.

5. The method of claim 3, wherein the obtaining the clothes image comprises:
obtaining a plurality of clothes images, wherein the plurality of clothes images all indicate a same piece of clothing, and different images in the plurality of clothes images indicate different view angles;
the generating the image dressing result of the front image based on the clothes image and the front image comprises:
generating the image dressing result of the front image based on the front image and a clothes image, which is comprised in the plurality of clothes images and whose view angle matches a view angle indicated by the front image; and
the obtaining the image dressing result of each of the at least one key image comprises:
generating the image dressing result of each of the at least one key image based on the plurality of clothes images and the at least one key image.

6. The method of claim 5, wherein the generating the image dressing result of each of the at least one key image based on the plurality of clothes images and the at least one key image comprises:
for any key image of the at least one key image, in response to there being a clothes image, which is comprised in the plurality of clothes images and whose view angle matches a view angle indicated by the key image, generating the image dressing result of the key image based on the key image and the clothes image whose view angle matches the view angle indicated by the key image.

7. The method of claim 5, wherein the generating the image dressing result of each of the at least one key image based on the plurality of clothes images and the at least one key image comprises:
in response to there being a difference between a view angle indicated by the plurality of clothes images and a view angle indicated by the at least one key image, for any clothes image, other than the clothes image whose view angle matches the view angle indicated by the front image, of the plurality of clothes images, generating an image dressing result corresponding to the clothes image based on the clothes image and an image, which is comprised in the target video and whose view angle matches a view angle indicated by the clothes image; and
for any key image of the at least one key image, generating the image dressing result of the key image based on image dressing results corresponding to each clothes image, other than the clothes image whose view angle matches the view angle indicated by the front image, of the plurality of clothes images, the image dressing result of the front image, a skeleton extraction result of the key image, and a background extraction result of the key image.

8. The method of claim 1, wherein an obtaining process of the clothes image comprises:
obtaining a target image, wherein an object in the target image has different clothes from the object in the target video; and
determining the clothes image based on a clothes extraction result of the target image.

9. The method of claim 1, wherein an obtaining process of the front image comprises:
obtaining a reference skeleton indicating the front view angle; and
determining the front image from the target video based on a similarity between the reference skeleton and a skeleton extraction result of each frame image in the target video, a similarity between the reference skeleton and a skeleton extraction result of the front image being not lower than a similarity between the reference skeleton and a skeleton extraction result of each of other frame images, other than the front image, in the target video.

10. The method of claim 1, wherein an obtaining process of the at least one key image comprises:
obtaining a reference skeleton indicating the front view angle;
selecting a first image from the target video based on a similarity between the reference skeleton and a skeleton extraction result of each frame image in the target video, a similarity between the reference skeleton and a skeleton extraction result of the first image being not higher than a similarity between the reference skeleton and a skeleton extraction result of each of other frame images, other than the first image, in the target video; and
determining the at least one key image based on the first image, wherein the at least one key image comprises the first image.

11. The method of claim 10, wherein after the determining the at least one key image based on the first image, the method further comprises:
selecting a second image from a difference set between the target video and the at least one key image, a similarity between a skeleton extraction result of the second image and a skeleton extraction result of each of the at least one key image being less than a preset threshold; and
updating the at least one key image based on the second image, the at least one updated key image comprising the second image, and the step of selecting the second image from the difference set between the target video and the at least one key image being continuously performed.

12. The method of claim 11, wherein before the generating the video dressing result of the target video based on the image dressing result, the at least one key image, and the skeleton extraction result of each frame image in the target video, the method further comprises:
in response to a number of images in the at least one key image exceeding a preset number, for any image in the at least one key image, summing similarities between a skeleton extraction result of the image and skeleton extraction results of other images than the image, in the at least one key image to obtain a sum corresponding to the image; and
deleting a third image satisfying a condition from the at least one key image based on the sum corresponding to each image in the at least one key image, a sum corresponding to each image in at least one remaining key image being not greater than a sum corresponding to the third image, and a number of images in the at least one remaining key image being the preset number.

13. The method of claim 11, wherein a determining process of the preset threshold comprises:
calculating an average value of similarities between the reference skeleton and the skeleton extraction result of each frame image in the target video; and
determining the preset threshold based on the average value.

14. The method of claim 9, wherein for any image in the target video, the similarity between the reference skeleton and the skeleton extraction result of the image indicates a similarity degree between a skeleton orientation angle determined from the skeleton extraction result of the image and a skeleton orientation angle determined from the reference skeleton.

15. The method of claim 1, wherein the at least one dimension comprises some or all of the posture, the view angle, a background, and light.

16. An electronic device, comprising: a processor and a memory,
wherein the memory is configured to store an instruction or a computer program, and
the processor is configured to execute the instruction or the computer program in the memory to cause the electronic device to perform a video generation method comprising:
obtaining a clothes image, a target video, a front image in the target video, and at least one key image in the target video, wherein the front image describes a state of an object in the target video in a front view angle, each of the at least one key image has a difference from the front image in at least one dimension, and the at least one dimension comprises a posture and/or a view angle;
generating an image dressing result of the front image based on the clothes image and the front image; and
generating a video dressing result of the target video based on the image dressing result, the at least one key image, and a skeleton extraction result of each frame image in the target video.

17. The electronic device of claim 16, wherein the generating the video dressing result of the target video based on the image dressing result, the at least one key image, and the skeleton extraction result of each frame image in the target video comprises:
generating the video dressing result of the target video based on the image dressing result, the at least one key image, the skeleton extraction result of each frame image in the target video, and a background extraction result of each frame image in the target video.

18. The electronic device of claim 16, further comprising:
obtaining an image dressing result of each of the at least one key image,
wherein the generating the video dressing result of the target video based on the image dressing result, the at least one key image, and the skeleton extraction result of each frame image in the target video comprises:
generating the video dressing result of the target video based on the image dressing result of the front image, the image dressing result of each of the at least one key image, and the skeleton extraction result of each frame image in the target video.

19. A non-transitory computer-readable medium, wherein an instruction or a computer program is stored in the computer-readable medium, and the instruction or the computer program, when running on a device, causes the device to perform a video generation method comprising:
obtaining a clothes image, a target video, a front image in the target video, and at least one key image in the target video, wherein the front image describes a state of an object in the target video in a front view angle, each of the at least one key image has a difference from the front image in at least one dimension, and the at least one dimension comprises a posture and/or a view angle;
generating an image dressing result of the front image based on the clothes image and the front image; and
generating a video dressing result of the target video based on the image dressing result, the at least one key image, and a skeleton extraction result of each frame image in the target video.

20. The non-transitory computer-readable medium of claim 19, wherein the generating the video dressing result of the target video based on the image dressing result, the at least one key image, and the skeleton extraction result of each frame image in the target video comprises:
generating the video dressing result of the target video based on the image dressing result, the at least one key image, the skeleton extraction result of each frame image in the target video, and a background extraction result of each frame image in the target video.
